(19) United States
(12) Patent Application Publication
(10) Pub. No.: US 2025/0371464 A1
(43) Pub. Date: Dec. 4, 2025

(54) APPARATUS AND METHOD FOR CHARGING AND DISCHARGING SCHEDULING OF ELECTRIC VEHICLE

(71) Applicants: HYUNDAI MOTOR COMPANY, Seoul (KR); KIA CORPORATION, Seoul (KR); KYUNGPOOK NATIONAL UNIVERSITY INDUSTRY-ACADEMIC COOPERATION FOUNDATION, Daegu (KR)

(72) Inventors: Jae Yun Jung, Hwaseong-si (KR); Sung Kyu Kim, Hwaseong-si (KR); Na Yeon Park, Hwaseong-si (KR); Hyun Sup Kim, Hwaseong-si (KR); Hye Seung Han, Hwaseong-si (KR); Min Kyu Lee, Hwaseong-si (KR); Se Kyung Han, Daegu (KR); Min Gyu Seo, Daegu (KR); Mu Su Kim, Daegu (KR); Hyeon Gyu Son, Daegu (KR); Young Gyu Hwang, Daegu (KR); Deok Ho Kong, Changwon-si (KR)

(73) Assignees: HYUNDAI MOTOR COMPANY, Seoul (KR); KIA CORPORATION, Seoul (KR); KYUNGPOOK NATIONAL UNIVERSITY INDUSTRY-ACADEMIC COOPERATION FOUNDATION, Daegu (KR)

(21) Appl. No.: 19/207,336

(22) Filed: May 13, 2025

(30) Foreign Application Priority Data
May 30, 2024 (KR) 10-2024-0070853

(51) Int. Cl. G06Q 10/0631; B60L 53/62; B60L 53/64; B60L 53/67; B60L 53/68; B60L 55/00; G06Q 50/06

(52) U.S. Cl. CPC G06Q 10/06315; B60L 53/62; B60L 53/64; B60L 53/67; B60L 53/68; B60L 55/00; G06Q 50/06

(57) ABSTRACT

An apparatus for charging and discharging scheduling of an electric vehicle is provided. The apparatus includes one or more processors and a memory storing one or more programs executed by the one or more processors, and each of the processors is configured to create a plurality of electric vehicle groups by clustering a plurality of electric vehicles according to a state of charge (SoC) for each time slot, set a first charging and discharging schedule for each electric vehicle group so that a total cost of an energy cost and a battery wear cost of all electric vehicle groups is minimized for each time slot, and set a second charging and discharging schedule for an individual electric vehicle belonging to each electric vehicle group based on the first charging and discharging schedule for each time slot.

### CROSS-REFERENCE TO RELATED APPLICATION(S)

This application claims priority to and the benefit of Korean Patent Application No. 10-2024-0070853, filed on May 30, 2024, the disclosure of which is incorporated herein by reference in its entirety.

### TECHNICAL FIELD

An embodiment of the present disclosure relates to an apparatus and method for charging and discharging scheduling of an electric vehicle.

### BACKGROUND

The use of electric vehicles continues to increase, and the electric vehicles may be useful given future environmental concerns. However, the change is posing new challenges for the power grid together with the rapid increase in renewable energy sources. For example, renewable energy sources such as solar energy produce excess energy during the day, while electric vehicle charging demand is concentrated in the morning and evening hours, so that a strain on the power grid may occur. The strain, a “duck curve” phenomenon, shows a stark mismatch between electricity demand and supply, and the mismatch may undermine the stability of the power grid.

Therefore, the management of charging and discharging of electric vehicles is becoming increasingly useful, and in particular, (e.g., effective) charging and discharging management of large-scale electric vehicle fleets may be considered an issue for managing the peak of power demand and preventing overload of the power grid. However, as the number of electric vehicles increases, the complexity of the management tasks also increases. The increase in electric vehicles is the main cause of increasing the computational burden of centralized control systems.

### SUMMARY

The present disclosure is directed to providing an apparatus and method for charging and discharging scheduling of an electric vehicle, capable of optimizing charging and discharging of a large-scale electric vehicle fleet.

According to an aspect of the present disclosure, an apparatus for charging and discharging scheduling of an electric vehicle is provided. The apparatus may include one or more processors and a memory storing one or more programs executed by the one or more processors, and each of the processors is configured to create a plurality of electric vehicle groups by clustering a plurality of electric vehicles according to a state of charge (SoC) for each time slot, set a first charging and discharging schedule for each electric vehicle group so that a total cost of an energy cost and a battery wear cost of (e.g., all) electric vehicle groups is minimized for each time slot, and set a second charging and discharging schedule for an individual electric vehicle belonging to each electric vehicle group based on the first charging and discharging schedule for each time slot.

The processor may perform clustering for a next time slot by applying the SoC changed according to the first charging and discharging schedule and the second charging and discharging schedule.

The processor may determine a group to which an electric vehicle scheduled to enter belongs using a scheduled entry time and a SoC of the electric vehicle scheduled to enter.

The processor may determine the group to which the electric vehicle scheduled to enter belongs according to the SoC in the time slot corresponding to the scheduled entry time of the electric vehicle scheduled to enter.

The processor may set the first charging and discharging schedule using an electric vehicle whose SoC is equal to or greater than a preset minimum SoC for each group.

The processor may determine a group to which an electric vehicle scheduled to exit belongs using a scheduled exit time and a target SoC of the electric vehicle scheduled to exit.

The processor may determine the group to which the electric vehicle scheduled to exit belongs according to the target SoC in the time slot corresponding to the scheduled exit time of the electric vehicle scheduled to exit.

The processor may set the first charging and discharging schedule according to a representative battery capacity and a charging/discharging efficiency set for each electric vehicle group.

The processor may set the first charging and discharging schedule so that a sum of the battery wear costs caused by movement between the electric vehicle groups according to the clustering is minimized.

The processor may set the second charging and discharging schedule to follow a target SoC of an individual electric vehicle based on the first charging and discharging schedule.

The processor may set the second charging and discharging schedule so that a sum of a charging amount and a discharging amount of the individual electric vehicle through the second charging and discharging schedule is equal to a charging amount and a discharging amount calculated through the first charging and discharging schedule.

According to another aspect of the present disclosure, a method performed by a computing device including one or more processors and a memory storing one or more programs executed by the one or more processors is provided. The method includes creating a plurality of electric vehicle groups by clustering a plurality of electric vehicles according to a SoC in a first time slot, setting a first charging and discharging schedule for each electric vehicle group so that a total cost of an energy cost and a battery wear cost of (e.g., all) electric vehicle groups is minimized in the first time slot, and setting a second charging and discharging schedule for an individual electric vehicle belonging to each electric vehicle group based on the first charging and discharging schedule in the first time slot.

In the creating of the plurality of electric vehicle groups, clustering for a second time slot may be performed by applying the SoC changed according to the first charging and discharging schedule and the second charging and discharging schedule.

The creating of the plurality of electric vehicle groups may further include determining a group to which an electric vehicle scheduled to enter belongs using a scheduled entry time and a SoC of the electric vehicle scheduled to enter.

The creating of the plurality of electric vehicle groups may further include determining a group to which an electric vehicle scheduled to exit belongs using a scheduled exit time and a target SoC of the electric vehicle scheduled to exit.

In the setting of the first charging and discharging schedule, the first charging and discharging schedule may be set according to a representative battery capacity and a charging/discharging efficiency set for each electric vehicle group.

In the setting of the first charging and discharging schedule, the first charging and discharging schedule may be set so that a sum of the battery wear costs caused by movement between the electric vehicle groups according to the clustering is minimized.

In the setting of the second charging and discharging schedule, the second charging and discharging schedule may be set to follow a target SoC of an individual electric vehicle based on the first charging and discharging schedule.

In the setting of the second charging and discharging schedule, the second charging and discharging schedule may be set so that a sum of a charging amount and a discharging amount of the individual electric vehicle through the second charging and discharging schedule is equal to a charging amount and a discharging amount calculated through the first charging and discharging schedule.

### BRIEF DESCRIPTION OF THE DRAWINGS

The above and other objects and features of the present disclosure will become more apparent to those of ordinary skill in the art by describing example embodiments thereof in detail with reference to the accompanying drawings, in which:

FIG. 1 is a diagram for an electric vehicle charging and discharging system according to an embodiment;

FIG. 2 is a block diagram of a configuration of an electric vehicle charging and discharging scheduling apparatus according to an embodiment;

FIG. 3 is a diagram for the operation of the electric vehicle charging and discharging scheduling apparatus according to the embodiment;

FIG. 4 is a diagram for the operation of a processor according to an embodiment;

FIG. 5 is a diagram for the operation of a processor according to another embodiment;

FIG. 6 is a diagram for the operation of a processor according to still another embodiment; and

FIG. 7 is a flowchart of a method of charging and discharging scheduling of an electric vehicle according to an embodiment.

### DETAILED DESCRIPTION

Hereinafter, embodiments of the present disclosure will be described in detail with reference to the accompanying drawings.

However, the technical idea of the present disclosure is not limited to some embodiments to be described but may be implemented in various different forms, and within the scope of the technical idea of the present disclosure, one or more among components in the embodiments may be used by being selectively combined and substituted.

Further, unless specifically defined and described, terms used in the embodiments of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the embodiments of the present disclosure are for the purpose of describing the embodiments and are not intended to limit the disclosure.

In the present specification, the singular forms may include the plural forms unless the context clearly dictates otherwise, and when described as “at least one (or one or more) among A, B, and (or) C,” it may include one or more of (e.g., all) possible combinations of A, B, and C.

In addition, in describing a component of embodiments of the present disclosure, terms such as first, second, A, B, (a), (b), etc. may be used.

These terms are for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes when two components are in direct contact with each other, and/or when one or more of other components are formed or disposed between the two components. Further, when a component is described as being “on (above) or below (under),” the description may include the meanings of an upward direction and a downward direction based on one component.

Hereinafter, embodiments may be described in detail with reference to the accompanying drawings, but identical or corresponding components are denoted by the same reference numerals regardless of figure numbers, and redundant descriptions thereof may be omitted.

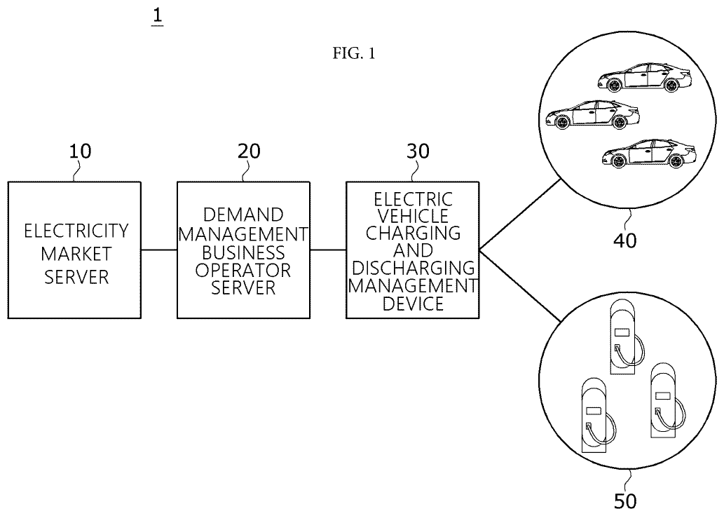

FIG. 1 is a diagram for describing an electric vehicle power management system according to an embodiment. Referring to FIG. 1, an electric vehicle power management system 1 may include an electricity market server 10, a demand management business operator server 20, and an electric vehicle charging and discharging management device 30.

The electricity market server 10 is an entity that operates the electricity market and may perform settlement according to a participation amount for each resource in different manners according to market settlement rules. The electricity market server 10 may mediate power transactions between a plurality of demand management business operator servers 20 using power transaction request information received from the demand management business operator servers 20.

The electricity market server 10 may refer to a server that contracts with a demand management business operator for power usage and discharge business volume and distributes profits to the demand management business operator through demand response and time section-based power unit price.

The demand management business operator server 20 may perform power transactions using charging and discharging information received from the linked electric vehicle charging and discharging management device 30, renewable energy generation amount information of a connected renewable energy generation system, and power demand information of a linked system.

In the embodiment, a demand management business operator may refer to a business operator that contracts with places that use large amounts of electricity, such as factories, large buildings, and parking towers, to reduce electricity consumption according to demand response, and thereby gains profits.

The power system linked to the demand management business operator may transmit power demand information to the demand management business operator server 20 at a preset cycle, upon request of the demand management business operator server, or when necessary. The power demand information may include power demand per hour and power usage reduction requirements of the linked system.

The demand management business operator server 20 may not only respond to the demand response through a request to reduce power usage, but also act like a power plant that transmits electricity that may be immediately used in the system back using electric vehicles 40, electric vehicle batteries, ESS, or the like.

For example, the demand management business operator server 20 may receive a next day's charging and discharging amount of the electric vehicle charging and discharging management device 30 at a specific time every day and bid the amount to the electricity market server, and may receive the successful bid amount from the electricity market server 10 according to the preset cycle and transmit the successful bid amount to the electric vehicle charging and discharging management device 30.

The electric vehicle charging and discharging management device 30 may directly manage electric vehicles 40 and charging stations 50 of customers participating in the V2X service, and may receive information on electric vehicles 40 and chargers, plug-in/out signals, and the like. The electric vehicle charging and discharging management device 30 may control the charging and discharging of individual electric vehicles 40 to determine a next day's charging and discharging bid amount and fulfill the successful bid amount with the goal of maximizing market participation profits.

The electric vehicle charging and discharging management device 30 may monitor information on electric vehicles 40 and charging stations 50 and provide various data for customers. The electric vehicle charging and discharging management device 30 may perform functions such as billing settlement, parking space management, charge and discharge control command generation, transmission, charge and discharge scenario control, and vehicle battery state diagnosis, and the like.

The electric vehicle charging and discharging management device 30 may include a controller 31.

The power system may include smart grid-related systems such as, for example, a substation, an electricity market server, a demand management business operator server, a renewable energy source, an energy storage system (ESS), or the like. The renewable energy source may be an energy source using wind power, solar power, geothermal power, or waste. The power system may supply power within a range of allowable power (or maximum power) (Pmax) (or allowable alternating current (IACmax)) to the charging stations 50 under the control of the controller 31.

In some cases, when a large number of electric vehicles 40 are concentrated at charging stations 50 in a specific area at the same time, the maximum allowable power of the power system may vary. That is, by inputting a reserve power source such as an energy storage system (ESS) or inputting a surrounding renewable energy source in the electricity market server 10 that controls the system operation, the demand management business operator server 20, or the energy management system (EMS), the power capacity may be increased and the increased power may be supplied to the charging stations.

The allowable power may be increased by the control of the controller 31 when the power supplied to the electric vehicles 40 is insufficient due to charging demand information about each electric vehicle 40 (charging demand amount of electric vehicle users). That is, the controller 31 may control a switch for additionally connecting (inputting) a renewable energy source (or energy storage system (ESS)) within the power system into a substation that supplies power to the charging stations 50 so that the allowable power of the power system increases when a charging load (a load of the electric vehicles) of the charging station 50 exceeds the allowable power of the power system.

The controller 31 may control the overall operation of components included in the electric vehicle charging and discharging management device 30. The controller 31 is an aggregator and may collect information on the battery capacity of the electric vehicle 40 connected to a charging station 50 through a wired or wireless communication network, a state of charge (SoC) of a battery of the electric vehicle 40, a rated current flowing through a power line, a rated voltage applied to the power line, or information on a charging request of an electric vehicle user (e.g., owner). The information on the charging request of the electric vehicle user may be transmitted to the controller 31 through a communication device included in each of the charging stations 50 or transmitted to the controller 31 through a communication device such as a user's mobile phone.

The controller 31 may exchange information with the power system through a wired or wireless communication network, and may exchange data with the charging station 50 through a LAN connection such as Ethernet, power line communication (PLC), or Wi-Fi, which is a wired or wireless communication network.

The controller 31 may control the power of the power system to be supplied to the charging station 50 within an allowable power range of the power system based on real-time information about the power system, state information about the electric vehicle 40, and charging demand information about each electric vehicle 40.

The real-time information about the power system may include information on the allowable power of the power system or information on the electricity rate of the power system, the state information about the electric vehicle 40 may include information (SoC) on a state of charge of the battery included in each electric vehicle 40, and the charging demand information may include a charging demand time, a scheduled entry time, a scheduled exit time, and a charging demand amount (target SoC) of an electric vehicle user.

The charging station 50 may charge batteries of a plurality of electric vehicles 40. Each charging station 50 may include an alternating current (AC) current limiter that performs current allocation operations to each electric vehicle 40. In addition, each charging station 50 may include a control module that exchanges information with a battery management system (BMS) of the electric vehicle 40 and the controller 31. By the control of the controller 31, the control module may control the current limiter (the AC current limiter) to provide a direct current charging current to each battery of the electric vehicle 40.

Each electric vehicle 40 may include the battery management system (BMS). The battery management system may control a battery charging process. Each electric vehicle 40 may function as an active load that demands power from the electric vehicle charging and discharging management device 30 during a charging time.

A charger that converts the alternating current of the power system into direct current to charge the battery of the electric vehicle 40 may be an on-board charger included in each electric vehicle 40 or an off-board charger included in each charging station 50.

The electric vehicle 40 may participate in electricity transactions by registering on a V2X platform. The user of the electric vehicle 40 may join the platform according to the electricity market the user wishes to participate in and register his or her expected entry and exit schedules until the next day. The electric vehicle 40 may transmit information on an expected plug-in time, an expected plug-out time, the SoC, and the available battery capacity to the electric vehicle charging and discharging management device 30.

The electric vehicle power management system 1 described above is a centralized control system and may adjust a charging and discharging schedule of electric vehicles by considering the time-based power price or the demand and supply of the power system. However, as the number of electric vehicles to be controlled increases, the computational burden and complexity for optimal scheduling are increasing.

The electric vehicle charging and discharging scheduling apparatus according to the embodiment has a technical effect of being capable of optimizing charging and discharging of such a large-scale electric vehicle fleet. The electric vehicle charging and discharging scheduling apparatus according to the embodiment may be included in a configuration of the electric vehicle charging and discharging management device or may be provided as a separate device. In the case where the electric vehicle charging and discharging scheduling apparatus is provided as a separate device, a separate wired or wireless communication device may be provided for communicating with the electric vehicle, an external server, a terminal, and the like.

In the embodiment, the electric vehicle charging and discharging scheduling apparatus may be described as being included in the electric vehicle charging and discharging management device 30 of FIG. 1 as an example.

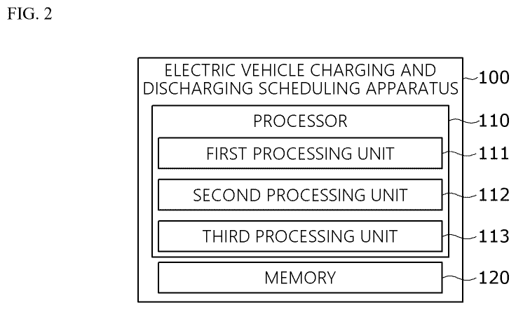

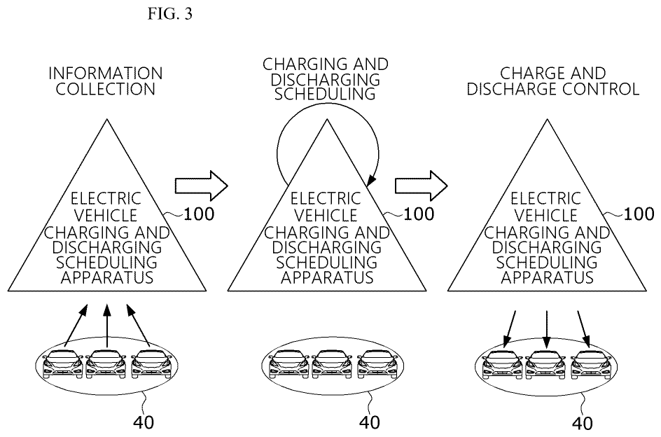

FIG. 2 is a block diagram of a configuration of an electric vehicle charging and discharging scheduling apparatus according to an embodiment, and FIG. 3 is a diagram for describing the operation of the electric vehicle charging and discharging scheduling apparatus according to the embodiment.

Referring to FIGS. 2 and 3, an electric vehicle charging and discharging scheduling apparatus 100 may include a processor 110 and a memory 120. In addition, the processor 110 according to the embodiment may include a first processing unit 111, a second processing unit 112, and a third processing unit 113.

The electric vehicle charging and discharging scheduling apparatus 100 according to the embodiment may be implemented in a logic circuit by hardware, firmware, software, or a combination thereof, and may also be implemented using a general-purpose or special-purpose computer. The apparatus may be implemented using a hardwired device, a field programmable gate array (FPGA), an application specific integrated circuit (ASIC), or the like. In addition, the apparatus 100 may be implemented as a system on chip (SoC) including one or more processors and controllers.

In addition, the electric vehicle charging and discharging scheduling apparatus 100 may be installed in a computing device or server equipped with hardware elements in the form of software, hardware, or a combination thereof. The computing device or server may refer to various devices including a communication device such as a communication modem for communicating with various devices or wired/wireless communication networks or the like, a memory for storing data for executing a program, and a microprocessor for executing the program to perform calculations and commands.

The first processing unit 111 may create at least one electric vehicle group by clustering a plurality of electric vehicles according to a state of charge (SoC) for each time slot. The time slot may refer to a preset time interval, and there may be an equal time interval between time slots.

The first processing unit 111 may collect the battery capacity of electric vehicles, the state of charge of the batteries of electric vehicles, the rated current flowing through a power line, the rated voltage applied to the power line, or information (e.g., on needs) from electric vehicle users.

The information (e.g., on needs) from electric vehicle users may include information such as a target SoC, a scheduled entry time, a scheduled exit time, and the like. The information (e.g., on needs) from electric vehicle users may be transmitted to the first processing unit 111 through a communication device included in each of the charging stations or transmitted to the first processing unit 111 through a communication device such as a user's mobile phone.

The first processing unit 111 may collect the aforementioned data and cluster a plurality of electric vehicles according to a SoC range to create an electric vehicle group. The first processing unit 111 may cluster a plurality of electric vehicles based on a preset SoC range and create at least one electric vehicle group. For example, the first processing unit 111 may create four electric vehicle groups by clustering electric vehicles with a SoC range of 0% or more and less than 25% into a first group, clustering electric vehicles with a SoC range of 25% or more and less than 50% into a second group, clustering electric vehicles with a SoC range of 50% or more and less than 75% into a third group, and clustering electric vehicles with a SoC range of 75% or more and 100% or less into a fourth group. The number of electric vehicle groups and SoC reference range may be variously set depending on conditions such as the number of electric vehicles, the power generation capacity of renewable energy, or the like.

The first processing unit 111 may perform clustering for the next time slot by applying a state of charge of batteries changed according to a first charging and discharging schedule and a second charging and discharging schedule. The SoC of the electric vehicles may be changed when charge and discharge control is performed according to the first charging and discharging schedule and the second charging and discharging schedule, as described below. Therefore, the first processing unit 111 may perform clustering again based on the changed SoC. The charge and discharge control for batteries may be performed for each preset time slot. Accordingly, the clustering process is (e.g., repeatedly) performed using SoC information changed for each time slot, and first charging and discharging scheduling and the second charging and discharging scheduling processes may also be repeatedly performed for each time slot.

The first processing unit 111 may determine a group to which an electric vehicle scheduled to enter belongs using the scheduled entry time and the state of charge of the battery of the electric vehicle scheduled to enter. The first processing unit 111 may determine the group to which the electric vehicle scheduled to enter belongs according to the SoC in a time slot corresponding to the scheduled entry time of the electric vehicle scheduled to enter. The first processing unit 111 may perform clustering by adding the electric vehicle to a time slot corresponding to the scheduled entry time of the electric vehicle. The first processing unit 111 may determine a time slot for performing clustering using previously collected scheduled entry time information and determine the group to which the electric vehicle belongs using the SoC information collected from the electric vehicle scheduled to enter.

The first processing unit 111 may determine a group to which an electric vehicle scheduled to exit belongs using the scheduled exit time and target battery capacity of the electric vehicle scheduled to exit. The first processing unit 111 may determine the group to which the electric vehicle scheduled to exit belongs according to the target SoC in a time slot corresponding to the scheduled exit time of the electric vehicle scheduled to exit. The first processing unit 111 may perform clustering by adding the electric vehicle to a time slot corresponding to the scheduled exit time of the electric vehicle. The first processing unit 111 may determine a time slot for performing clustering using previously collected scheduled exit time information and determine the group to which the electric vehicle belongs using the target SoC information collected from the electric vehicle scheduled to exit.

The second processing unit 112 may set the first charging and discharging schedule so that a sum of battery wear costs caused by group movement of electric vehicles according to clustering is minimized.

The second processing unit 112 may determine the number of electric vehicles to be moved for each group so that the total cost of an energy cost and a battery wear cost of (e.g., all) electric vehicle groups is minimized for each slot. A life of the battery of the electric vehicle may be largely determined by two factors. A factor may be is the number of charge-discharge cycles, and another factor may be the charge-discharge ratio. That is, the more charge-discharge cycles there are, the shorter the battery life becomes. This is because each time the battery is charged and then discharged, slight degradation occurs. In general, battery performance drops to 80% or lower after 1,000 to 2,000 charge-discharge cycles.

Further, the charge-discharge ratio also affects the battery life. Frequent charging without fully discharging may prolong the battery life more than fully discharging and then fully charging. This is because a greater shock is applied to the battery when charging after full discharging.

The second processing unit 112 according to the embodiment may set the first charging and discharging schedule so that (e.g., all) electric vehicles belong to an electric vehicle group matching the target SoC in a time slot corresponding to an exit time. As an individual electric vehicle performs charging and discharging for each time slot, its SoC may be changed, and the group to which the electric vehicle belongs may be changed in the next time slot depending on the changed SoC value. The change in SoC due to charging and discharging may cause battery wear, and the second processing unit 112 may set the first charging and discharging schedule by taking the battery wear cost into account. The second processing unit 112 may set the first charging and discharging schedule so that electric vehicles belonging to (e.g., all) groups may follow the target SoC at the exit time and at the same time, the battery wear caused by the change in SoC is minimized. That is, the second processing unit 112 may determine that an individual battery wear cost occurs whenever group movement of an individual electric vehicle occurs due to the change in SoC, and calculate a battery wear cost in a specific time slot by adding up the individual battery wear costs for (e.g., all) electric vehicles.

In addition, the second processing unit 112 may calculate energy costs using electricity market data and charging infrastructure data. The energy cost may refer to the cost of buying and selling power to charge and discharge electric vehicles. That is, the second processing unit 112 according to the embodiment may collect electricity market data from a power supplier, collect charging infrastructure data from a charging station, and then determine power capable of being supplied so that the clustered electric vehicles may follow the target SoC. The second processing unit 112 may purchase power from the power supplier when it is difficult to supply target power through charging infrastructure data. Alternatively, the second processing unit 112 may sell spare power through the power supplier or a power transaction intermediary when it is possible to supply the target power through charging infrastructure data and there is the spare power. The second processing unit 112 may calculate the energy cost by adding up the cost of purchasing power and the cost of selling power.

The second processing unit 112 may set the first charging and discharging schedule so that the total cost of the aforementioned energy cost and battery wear cost is minimized and determine the number of electric vehicles to be moved for each group according to the first charging and discharging schedule. In this case, the second processing unit 112 may set the first charging and discharging schedule by considering the exit time and the target SoC of an individual electric vehicle. For example, the second processing unit 112 may estimate the energy cost to follow the target SoC according to the exit time and estimate the battery wear cost that occurs according to the change in SoC. The second processing unit 112 may set the total cost of the estimated energy cost and battery wear cost as an objective function and minimize the total cost through an optimization process of the set objective function.

The second processing unit 112 may perform scheduling that optimizes charging and discharging demands of (e.g., all) electric vehicles based on a clustered model. The second processing unit 112 may set the first charging and discharging schedule according to a representative battery capacity and a charging/discharging efficiency set for each electric vehicle group. The representative battery capacity for each electric vehicle group may be determined as a value within a SoC range of the corresponding electric vehicle group. For example, the representative battery capacity for each electric vehicle group may be determined as a median value of the SoC range of the corresponding electric vehicle group. In addition, the charging efficiency may be calculated by comparing the amount of power supplied to the electric vehicle battery or the amount of power discharged from the electric vehicle battery with the SoC.

The second processing unit 112 may set the first charging and discharging schedule using the product of the representative battery capacity for each group and the charging/discharging efficiency of the electric vehicle belonging to the group.

In this case, the second processing unit 112 may set the first charging and discharging schedule using an electric vehicle that complies with a preset minimum SoC value for each group. The minimum SoC value for each group is a reference SoC value set to participate in the first charging and discharging schedule and may be set in advance according to a charging environment. The second processing unit 112 may set the first charging and discharging schedule using (e.g., only) an electric vehicle that complies with the minimum SoC value of the group among the electric vehicles belonging to the group. In the case where the SoC value is changed according to the charge and discharge control, an electric vehicle that has been excluded when the first charging and discharging schedule has been created may be considered again in the first charging and discharging schedule creation process when the electric vehicle satisfies a minimum SoC condition.

That is, the second processing unit 112 may consider the scheduled exit time and the target SoC for an individual electric vehicle, determine the number of vehicles to be moved for each group so that the total cost of the energy cost and the battery wear cost is minimized, and determine charging power and discharging power amounts for each group by considering the representative battery capacity and the charging/discharging efficiency. The first charging and discharging schedule may be information including the number of vehicles to be moved for each group according to the time slot and the charging and discharging power amounts for each group.

The third processing unit 113 may set the second charging and discharging schedule of an individual electric vehicle belonging to each electric vehicle group based on the first charging and discharging schedule for each time slot. The third processing unit 113 may subdivide the charging and discharging schedule of the individual electric vehicle belonging to each group based on the first charging and discharging schedule generated based on the clustered group. In this case, the second charging and discharging schedule may be set by considering an individual operating condition of each electric vehicle. That is, the second charging and discharging schedule may refer to a charging and discharging schedule of an individual electric vehicle belonging to a group.

The third processing unit 113 may set the second charging and discharging schedule to follow the target battery capacity of the individual electric vehicle based on the first charging and discharging schedule. The third processing unit 113 may set the second charging and discharging schedule so that the sum of the charging and discharging amounts of individual electric vehicles through the second charging and discharging schedule is equal to the charging and discharging amounts calculated through the first charging and discharging schedule.

The second charging and discharging schedule may include a charging power amount and a discharging power amount of an individual electric vehicle for each group. In this case, the third processing unit 113 may determine the charging and discharging power amounts of the individual electric vehicle to follow the target SoC of the individual electric vehicle. The third processing unit 113 may set the second charging and discharging schedule so that a difference value between the SoC of the electric vehicle and the target SoC becomes the minimum after actual charging or discharging according to the second charging and discharging schedule. In this case, the third processing unit 113 may set a SoC upper limit value and a SoC lower limit value according to an available capacity range of the battery of the individual electric vehicle and set the second charging and discharging schedule so that the electric vehicle may be charged and discharged within the range of the SoC upper limit value and the SoC lower limit value.

For example, the third processing unit 113 may set a difference value between the SoC of the electric vehicle after charge and discharge control and the target SoC as an objective function and minimize the difference value through an optimization process of the set objective function. The third processing unit 113 may perform optimization of the objective function by applying the gradient descent method, the steepest descent method, or the stochastic gradient descent method.

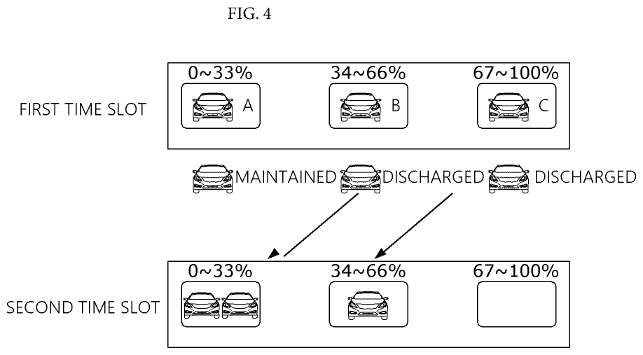

FIG. 4 is a diagram for describing the operation of a processor according to an embodiment.

Referring to FIG. 4, the processor divides the SoC range into three groups to create a first group of 0% to 33%, a second group of 34% to 66%, and a third group of 67% to 100%. The processor uses the SoCs of the electric vehicles collected in the first time slot to cluster vehicles A into the first group, vehicles B into the second group, and vehicles C into the third group.

Individual electric vehicles and charging stations perform charge and discharge control according to the first charging and discharging schedule and the second charging and discharging schedule, and the SoC value changes according to charging and discharging. The processor performs clustering again in a second time slot using the changed SoC value. The processor uses the SoCs of the electric vehicles collected in the second time slot to cluster the vehicles A and B into the first group, and cluster the vehicle C into the second group.

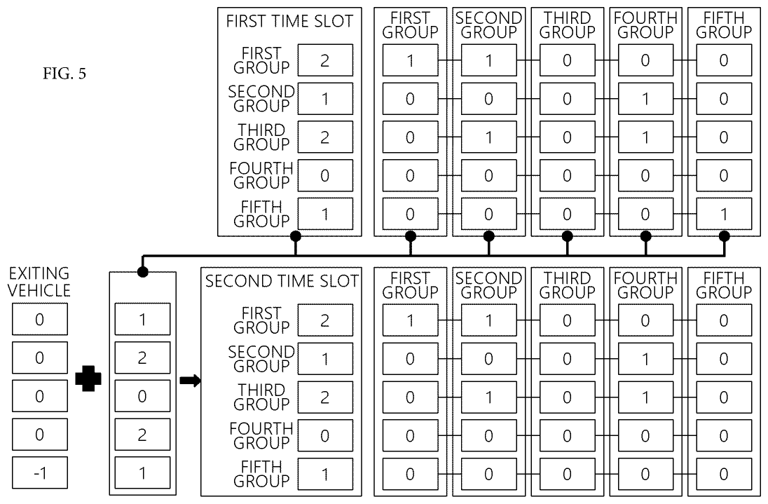

FIG. 5 is a diagram for describing the operation of a processor according to another embodiment.

Referring to FIG. 5, the processor may create five electric vehicle groups by clustering electric vehicles having a SoC range of 0% or more and less than 20% into a first group, clustering electric vehicles having a SoC range of 20% or more and less than 40% into a second group, clustering electric vehicles having a SoC range of 40% or more and less than 60% into a third group, clustering electric vehicles having a SoC range of 60% or more and less than 80% into a fourth group, and clustering electric vehicles having a SoC range of 80% or more and 100% or less into a fifth group.

In FIG. 5, for each time slot, the number of electric vehicles for each group is listed on the left and the number of vehicles to be moved for each group according to the first charging and discharging schedule is listed on the right. In the first time slot, the first group has two electric vehicles, the second group has one electric vehicle, the third group has two electric vehicles, the fourth group has no electric vehicle, and the fifth group has one electric vehicle.

The processor determines the number of electric vehicles to be moved by considering the energy cost and the battery wear cost. The number of electric vehicles to be moved is shown on the right. A determination is made such that in the first time slot, one electric vehicle belonging to the first group moves to the second group, one electric vehicle belonging to the second group moves to the fourth group, and one of the electric vehicles in the third group moves to the second group and the remaining one moves to the fourth group.

The processor may generate the second charging and discharging schedule according to the first charging and discharging schedule so that the charge and discharge control of the individual electric vehicle may be performed. The processor performs clustering in the second time slot as shown below in FIG. 5 using the SoC changed according to the charge and discharge control. In this case, the processor performs clustering by considering exiting vehicles. That is, one electric vehicle belonging to the fifth group is excluded from the second time slot set as the scheduled exit time in a state where the target SoC is satisfied. In addition, the remaining electric vehicles are clustered according to the changed SoC, so that the first group has one electric vehicle, the second group has two electric vehicles, the third group has no electric vehicle, the fourth group has two electric vehicles, and the fifth group has no electric vehicle.

Then, the processor sets the first charging and discharging schedule in the second time slot to determine the number of vehicles to be moved for each group.

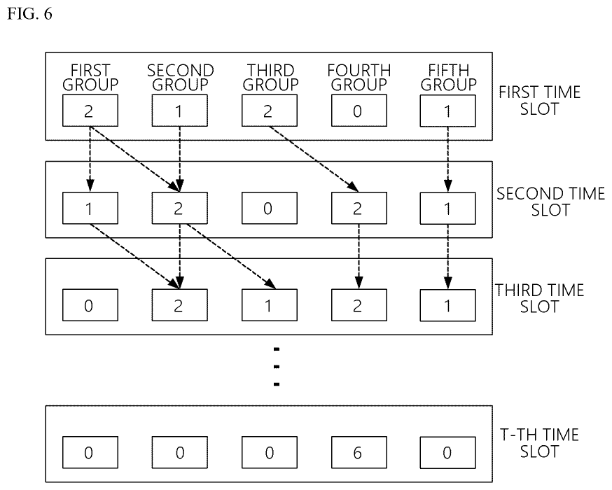

FIG. 6 is a diagram for describing the operation of a processor according to still another embodiment.

Referring to FIG. 6, a process of performing clustering and charging and discharging scheduling during T time slots (T is a natural number greater than 1) to follow the target SoC when a target SoC of an electric vehicle is 60% to 80% is illustrated. In FIG. 6, five electric vehicle groups are created as in FIG. 5. The processor repeats clustering and generating first and second charging and discharging schedules from a first time slot to a T-th time slot. The processor may determine the number of vehicles to be moved in each time slot so that the energy cost and the battery wear cost are minimized during a phase where (e.g., all) electric vehicles are following the target SoC. As a result, electric vehicles (e.g., all electric vehicles) follow the target SoC in the T-th time slot.

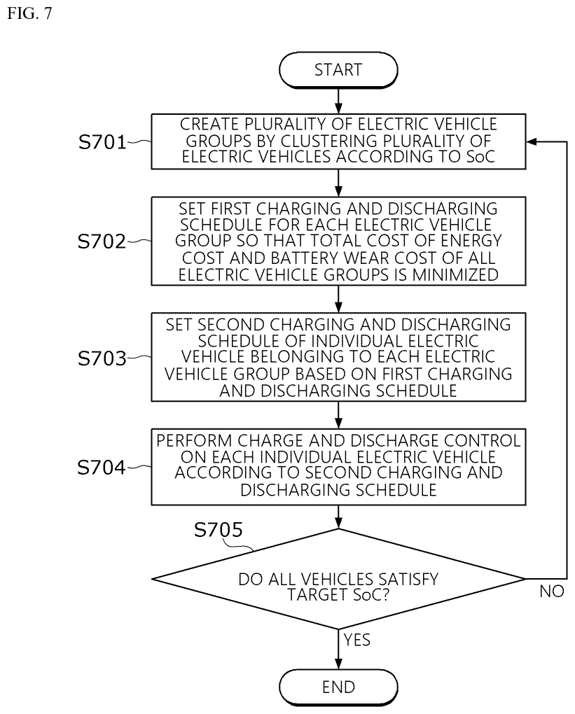

FIG. 7 is a flowchart of a method of charging and discharging scheduling of an electric vehicle according to an embodiment. Referring to FIG. 7, in a first time slot, the processor clusters a plurality of electric vehicles according to a SoC to create a plurality of electric vehicle groups. In this case, the processor may additionally determine a group to which an electric vehicle scheduled to enter belongs using a scheduled entry time and the SoC of the electric vehicle scheduled to enter. In addition, the processor may determine a group to which an electric vehicle scheduled to exit belongs using a scheduled exit time and the target SoC of the electric vehicle scheduled to exit (S701).

Next, the processor sets a first charging and discharging schedule for each electric vehicle group so that a total cost of an energy cost and a battery wear cost of (e.g., all) electric vehicle groups is minimized. The processor may set the total cost of an estimated energy cost and battery wear cost as an objective function and minimize the total cost through an optimization process of the set objective function. The first charging and discharging schedule may be information including the number of vehicles to be moved for each group according to the time slot and the charging and discharging power amounts for each group. The processor may consider the scheduled exit time and the target SoC for an individual electric vehicle, determine the number of vehicles to be moved for each group so that the total cost of the energy cost and the battery wear cost is minimized, and determine charging and discharging power amounts for each group by considering the representative battery capacity and the charging/discharging efficiency (S702).

Next, the processor sets a second charging and discharging schedule of an individual electric vehicle belonging to each electric vehicle group based on the first charging and discharging schedule. The second charging and discharging schedule may include a charging power amount and a discharging power amount of an individual electric vehicle for each group. The processor may determine charging and discharging power amounts of the individual electric vehicle to follow the target SoC of the individual electric vehicle. The processor may set a difference value between the SoC of the electric vehicle after charge and discharge control and the target SoC as an objective function and minimize the difference value through an optimization process of the set objective function. In this case, the processor may set the second charging and discharging schedule so that the sum of the charging and discharging amounts of individual electric vehicles through the second charging and discharging schedule is equal to the charging and discharging amounts calculated through the first charging and discharging schedule (S703).

Next, each individual electric vehicle performs charge and discharge control according to the second charging and discharging schedule (S704).

Next, the processor determines whether the charging and discharging scheduling is completed (S705), and when not completed, creates a plurality of electric vehicle groups by clustering according to the SoC changed in the second time slot consecutive from the first time slot. For example, the processor may determine that charging and discharging scheduling is complete when (e.g., all) individual vehicles participating in the clustering satisfy the target SoC.

In the subsequent operations, the processor performs a process of generating the first charging and discharging schedule and the second charging and discharging schedule using the newly clustered groups.

The term “unit” used in the present embodiment refers to software component or hardware components such as a field-programmable gate array (FPGA) or an application specific integrated circuit (ASIC), and “unit” performs (e.g., certain) functions. However, “unit” may not be limited to software or hardware. “Unit” may be configured to be in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro codes, circuits, data, a database, data structures, tables, arrays, and variables. Functions provided in the components and the “unit” may be coupled with lesser numbers of components and “units,” or may be further divided into additional components and “units.” Furthermore, the components and “units” may be implemented to reproduce one or more CPUs in a device or a security multimedia card.

An apparatus and method for charging and discharging of an electric vehicle according to an embodiment may optimize the charging and discharging efficiency of a large-scale electric vehicle fleet through charging and discharging scheduling of clustered electric vehicles.

In addition, the energy efficiency of the (e.g., entire) electric vehicle fleet may be maximized and the stability of a power system may be enhanced.

In addition, the amount of computation of a problem of optimizing the charging and discharging scheduling of large-scale electric vehicles may be reduced.

In addition, customized scheduling may be performed considering a charge state of a battery of an individual electric vehicle.

Although the embodiments of the present disclosure have been described above, it is understood that those skilled in the art may make various changes and modifications to the present disclosure without departing from the spirit and scope of the present disclosure set forth in the claims below.

What is claimed is:

1. An electrical vehicle control apparatus for scheduling charging and discharging of an electric vehicle, comprising:
a memory storing computer-executable instructions; and
at least one processor configured to access the memory and execute the instructions, wherein the instructions comprise:
clustering, via the processor, a plurality of electric vehicles into an electrical vehicle group according to a state of charge (SoC) for a time slot;
setting, via the processor, a first charging and discharging schedule for the electric vehicle group, wherein a total cost of an energy cost and a battery wear cost of the electric vehicle group is minimized for the time slot;
setting, via the processor, a second charging and discharging schedule for an electric vehicle of the electric vehicle group based on the first charging and discharging schedule for the time slot; and
charging the electric vehicle based on the first charging and discharging schedule or the second charging or discharging schedule.

2. The electrical vehicle control apparatus of claim 1, wherein the instructions further comprise clustering, via the processor, the plurality of electric vehicles for a next time slot by applying the SoC changed according to the first charging and discharging schedule and the second charging and discharging schedule.

3. The electrical vehicle control apparatus of claim 1, wherein the instructions further comprise determining, via the processor, an electric vehicle group for an entering electric vehicle using a scheduled entry time and a SoC of the entering electric vehicle.

4. The electrical vehicle control apparatus of claim 3, wherein the instructions further comprise determining, via the processor, the electric vehicle group for the entering electric vehicle according to the SoC in the time slot corresponding to the scheduled entry time of the entering electric vehicle.

5. The electrical vehicle control apparatus of claim 4, wherein the instructions further comprise setting, via the processor, the first charging and discharging schedule using an electric vehicle whose SoC is equal to or greater than a preset minimum SoC for the electric vehicle group.

6. The electrical vehicle control apparatus of claim 1, wherein the instructions further comprise determining, via the processor, an electric vehicle group for an exiting electric vehicle using a scheduled exit time and a target SoC of the exiting electric vehicle.

7. The electrical vehicle control apparatus of claim 6, wherein the instructions further comprise determining, via the processor, the electric vehicle group for the exiting electric vehicle according to the target SoC in the time slot corresponding to the scheduled exit time of the exiting electric vehicle.

8. The electrical vehicle control apparatus of claim 1, wherein the instructions further comprise setting, via the processor, the first charging and discharging schedule according to a representative battery capacity and a charging and discharging efficiency set for the electric vehicle group.

9. The electrical vehicle control apparatus of claim 1, wherein the instructions further comprise setting, via the processor, the first charging and discharging schedule, wherein a sum of the battery wear costs caused by movement between one electric vehicle group to another electric vehicle group according to the clustering is minimized.

10. The electrical vehicle control apparatus of claim 1, wherein the instructions further comprise setting, via the processor, the second charging and discharging schedule to follow a target SoC of an electric vehicle based on the first charging and discharging schedule.

11. The electrical vehicle control apparatus of claim 10, wherein the instructions further comprise setting, via the processor, the second charging and discharging schedule, wherein a sum of a charging amount and a discharging amount of the electric vehicle through the second charging and discharging schedule is equal to a charging amount and a discharging amount calculated through the first charging and discharging schedule.

12. A method for an electric vehicle, which is performed by a computing device, a memory storing computer-executable instructions, and at least one processor configured to access the memory and execute the instructions, the method comprising:
creating a plurality of electric vehicle groups by clustering a plurality of electric vehicles according to a state of charge (SoC) in a first time slot;
setting a first charging and discharging schedule for an electric vehicle group, wherein a total cost of an energy cost and a battery wear cost of the electric vehicle group is minimized in the first time slot; and
setting a second charging and discharging schedule for an individual electric vehicle of the electric vehicle group based on the first charging and discharging schedule in the first time slot.

13. The method of claim 12, wherein in the creating of the plurality of electric vehicle groups, clustering for a second time slot is performed by applying the SoC changed according to the first charging and discharging schedule and the second charging and discharging schedule.

14. The method of claim 12, wherein the creating of the plurality of electric vehicle groups further includes determining a group to which an electric vehicle scheduled to enter belongs using a scheduled entry time and a SoC of the electric vehicle scheduled to enter.

15. The method of claim 12, wherein the creating of the plurality of electric vehicle groups further includes determining a group to which an electric vehicle scheduled to exit belongs using a scheduled exit time and a target SoC of the electric vehicle scheduled to exit.

16. The method of claim 12, wherein in the setting of the first charging and discharging schedule, the first charging and discharging schedule is set according to a representative battery capacity and a charging and discharging efficiency set for the electric vehicle group.

17. The method of claim 12, wherein in the setting of the first charging and discharging schedule, the first charging and discharging schedule is set, wherein a sum of the battery wear costs caused by movement between one electric vehicle group to another electric vehicle group according to the clustering is minimized.

18. The method of claim 12, wherein in the setting of the second charging and discharging schedule, the second charging and discharging schedule is set to follow a target SoC of an individual electric vehicle based on the first charging and discharging schedule.

19. The method of claim 18, wherein in the setting of the second charging and discharging schedule, the second charging and discharging schedule is set, wherein a sum of a charging amount and a discharging amount of the individual electric vehicle through the second charging and discharging schedule is equal to a charging amount and a discharging amount calculated through the first charging and discharging schedule.

20. The method of claim 12, further comprising charging the individual electric vehicle of the electric vehicle group in the first time slot based on the first charging and discharging schedule or the second charging or discharging schedule.
